(19) United States
(12) Patent Application Publication
(10) Pub. No.: US 2026/0308055 A1
(43) Pub. Date: Oct. 8, 2026

(54) Composition For Producing Components

(71) Applicant: Kruner Industries AG, Sarnen (CH)

(72) Inventors: Helmut Lerner, Gunselsdorf (AT); Robert Rentz, Gunselsdorf (AT)

(21) Appl. No.: 19/482,579

(22) PCT Filed: May 8, 2024
(86) PCT No.: PCT/AT2024/060201

§ 371 Date: Nov. 7, 2025

(30) Foreign Application Priority Data
May 10, 2023 (AT) A50363/2023

(51) Int. Cl. C04B 14/10; C04B 14/06; C04B 22/08; C04B 33/04; C04B 33/13; C04B 103/10

(52) U.S. Cl. CPC C04B 14/106; C04B 14/06; C04B 22/08; C04B 33/04; C04B 33/131; C04B 2103/10

(57) ABSTRACT

According to the invention, a composition for the production of components is provided, comprising solid components which have at least one base material and meta-clay, as well as an activation solution, wherein the activation solution has more than 5% by mass of alkali silicates, the mass of the base material is 200% to 500% of the mass of the meta-clay and the ratio between the mass of the activation solution and the mass of the meta-clay is greater than 1.

### REFERENCE TO PENDING APPLICATION

The application claims the benefit of pending PCT application serial number PCT/AT2024/060201, entitled COMPOSITION FOR PRODUCING COMPONENTS.

### BACKGROUND

The invention relates to a composition for producing components, comprising solid constituents which contain at least one base material and meta-clay, as well as an activation solution.

A variety of compositions and processes are known from the prior art for producing components such as bricks or walls. Wall stones can, for example, be hewn directly from rock or formed and fired as mud bricks or clay bricks in order to obtain sufficient strength values for the production of walls.

A well-known way to produce components is to prepare a geopolymer composition and then extrude it, thereby forming a component. A special composition or a process for producing a geopolymer component is described in EP 2727894 B1. In this process, meta-alumina, clay and an activating solution are first mixed together, then the resulting composition is extruded and finally the shaped component is dried. In the composition used, clay is added which has a mass of 5% to 40% by mass of the mass of the meta-clay. The ratio between the activation solution and the solid components, especially the meta-clay and the clay, is between 0.25 and 0.85. The activation solution also contains sodium or potassium silicate in a proportion between 0 and 20% by mass. This process can be used to produce components with a strength of up to approx. 30 MPa.

A disadvantage of the known processes or compositions for producing geopolymer components is the low strength, which is significantly below the strength that can be achieved, for example, with conventional fired bricks.

### SUMMARY

It is therefore an object of the invention to provide a composition which enables greater strength of the finished component.

### BRIEF DESCRIPTION OF THE DRAWINGS

FIG. 1 shows a schematic representation of a method according to the invention, which is essentially the same for the production of all three examples.

### DETAILED DESCRIPTION

According to the invention, in a composition of the type mentioned at the outset, it is provided that the activation solution has more than 5% mass proportions of alkali silicates, the mass of the base material is 200% to 500% of the mass of the meta-clay and the ratio between the mass of the activation solution and the mass of the meta-clay is greater than 1.

According to the invention, the solid components therefore comprise meta-clay. Furthermore, the solid components comprise a base material which preferably consists either (only) of clay, (only) of sand or clay and sand. Further, the mass of the clay and/or sand is 200% to 500% of the mass of the meta-clay. If the base material has only clay and no sand, the mass of the clay is 200% to 500% of the mass of the meta-clay. If the base material has only sand and no clay, the mass of the sand is 200% to 500% of the mass of the meta-clay. It is preferably provided that the base material comprises clay and sand or consists of clay and sand. It is particularly preferred that the ratio between the mass of the clay and the mass of the sand is between 0.2:1 and 4:1, preferably between 0.5:1 and 2:1, particularly preferably between 0.8:1 and 1.2:1, in particular approximately 1:1.

The composition can be mixed to form a substantially homogeneous mass which is then used to form a component. The mass provided by the composition is also preferably kneadable in order to ensure good formability.

The composition preferably contains no other components apart from the explicitly listed components, in particular the base material, the meta-clay and the activation solution, possibly apart from minor impurities.

Clay (or clay minerals) comprises layered silicates, which have a layer-like crystal structure made of silicon and oxygen, as well as hydrogen and usually magnesium and aluminum. The silicate anions consist of layers of corner-connected SiO₄ tetrahedra. These include, for example, mica, chlorite, smectite and kaolin. The clay can be dried or wet before it is mixed with the other ingredients. It is preferably provided that the clay is not thermally treated before mixing with the other components of the composition according to the invention.

In the context of the invention, meta-clay is understood to mean clay that has been treated at high temperatures (approx. 500° C. to 900 ° C.), so that bound water is removed and the structure or the crystal lattice changes. Meta-clay consists predominantly of reactive silicon dioxide and aluminum oxide. A well-known example of this is meta-kaolin, which is kaolin that has been treated at approximately 550° C. to 850 ° C.

By mixing the composition according to the invention, a geopolymer is formed due to a chemical reaction between the solid components, in particular the meta-clay, and the activation solution. The geopolymer according to the invention has the property that, after a curing time following the forming of a component (approx. 14 days), it has a high compressive strength, which can be, for example, approximately 60 MPa (N/mm²). Furthermore, it is not necessary for heat or pressure to be actively applied during curing. The hardening can therefore take place in the ambient air. It is preferably provided that the curing takes place at an air temperature of at least 20° C. and at least 50% humidity (rH; relative humidity). Curing is particularly preferably carried out at an air temperature of 20° C.-30° C. and a relative humidity of the air of 50% to 90%, preferably 50% to 80%.

It is preferably provided that the base material contains sand, preferably quartz sand, wherein the mass of the sand is preferably 10% to 500%, particularly preferably 100% to 300% of the mass of the meta-clay. This further increases the strength of the composition when dried. The solid components, in particular the clay and the meta-clay and possibly the sand, are preferably in powder form when they are mixed with the activation solution. The sand can be dry or wet before mixing with the other ingredients.

The sand, in particular the quartz sand, preferably has a grain size of 0.05 to 0.5 mm, particularly preferably 0.1 to 0.2 mm.

The moisture content of the individual components, in particular of clay and/or sand, can be determined before or during the production of the composition and the recipe of the composition can be adjusted if necessary, for example by adding more or less water to the activation solution.

The base material can also be or have one or more of the following materials:
Wood (materials), such as e.g.
   Veneer strips
   Leftover veneer
   Wood shavings (preferably 100 to 200 mm long, 10 to 50 mm wide and 0.6 to 1.5 mm thick)
   Wood chippings (preferably 0.5 to 3 cm long)
   Wood chips, sticks of wood, wood veneer
Plastic (leftovers), such as e.g.
   Finely ground plastic powder (preferably with grain sizes of 0.15 to 0.50 mm)
   Plastic granules, ground or extruded (preferably with grain sizes of 1 to 5 mm)
   Chopped pieces of plastic
Recyclates, Such As E. G.
   made of plastics
   made of building materials, ceramics, road surfaces and/or metals
   from mineral construction waste (preferably ground into grain sizes of 0.1 to 50 mm)
Lightweight mineral fillers, such as e.g.
   Glass balls
   Polystyrene, for example expanded polystyrene EPS (“Styrofoam”) or extruded polystyrene XPS
   PU foam (leftovers)
   Fillers for light materials such as foam, expanded clay, expanded glass, expanded slate, foam glass, perlite, vermiculite, cellulose fibers or flakes, expanded plastics
Glass (leftovers), such as e.g.
   Broken glass
   Optical functional elements such as glass balls as reflectors
Fibers, such as e.g.
   Mineral wool, glass fibers, carbon fibers, wood wool, plant fibers, straw, hair
Waste from the food industry (preferably difficult to compost), such as e. g.
   Kernels and shells

The activation solution is preferably a liquid. This allows easy mixing with the solid portions of the composition.

In addition to the alkali silicates, the activation solution preferably comprises a hydroxide, particularly preferably potassium hydroxide and/or sodium hydroxide, and/or rubidium hydroxide and/or cesium hydroxide.

Furthermore, it is preferably provided that the alkali silicates are sodium silicates and/or potassium silicates. Alternatively or additionally, the alkali silicates can also include lithium silicates. The use of sodium silicates, potassium silicates and/or lithium silicates (water glass) in liquid form enables simple alkaline activation of the solid components of the composition according to the invention. Although lithium water glass has the best reactivity, it is more expensive than sodium water glass and potassium water glass.

It is preferably provided that the activation solution comprises potassium hydroxide and potassium silicate. An activation solution which comprises potassium hydroxide and potassium silicate preferably contains no further hydroxide and no further silicate. Furthermore, it is preferably provided that the activation solution comprises sodium hydroxide and sodium silicate. An activation solution which comprises sodium hydroxide and sodium silicate preferably contains no further hydroxide and no further silicate.

It is preferably provided that the activation solution has between 20% and 90% by mass, particularly preferably between 40% and 80%, in particular approximately 50% to 70% by mass, of alkali silicates. The strength of the end product, i.e. a component, that can be achieved is highest in these areas.

Furthermore, it is preferably provided that the base material has clay, the mass fraction of the clay preferably being 200% to 400%, particularly preferably 250% to 350%, of the mass fraction of the meta-clay. With this ratio between clay and meta-clay, there is a favorable ratio between reactive material and fillers in order to be able to produce a stable component.

In order to further increase the strength of the component formed, it is preferably provided that the ratio between the mass of the activation solution and the mass of the meta-clay is between 1.1 and 1.6, particularly preferably between 1.25 and 1.35. In addition, this ratio has a positive effect on the flowability of the composition and thus the ease of processing of the composition.

Furthermore, it is preferably provided that the ratio between the mass of the activation solution and the mass of the solid components is between 0.2 and 0.4, particularly preferably between 0.25 and 0.35. With this ratio, good kneadability of the composition can be achieved, which improves the processability into a component.

In a preferred embodiment it is provided that the meta-clay comprises meta-kaolin. It is particularly preferred that the meta-clay is meta-kaolin. Meta-Kaolin is proven and well suited for use in geopolymers.

The activation solution preferably contains water (H2O). This serves in particular to improve miscibility and connection of the individual components of the composition during mixing.

The composition preferably comprises, based on the total mass of the composition, 50% to 70% by mass of base material, 5% to 20% by mass of meta-clay, 5% to 20% by mass of alkali silicates, 0% to 10% by mass of hydroxide and 0% to 25% by mass water.

The invention further relates to a method for producing a component, in which, in a first step, a mixture of a composition comprising solid components which have at least one base material and meta-clay, as well as an activation solution, is produced, the activation solution has more than 5% by mass of alkali silicates, the mass of the base material is 200% to 500% of the mass of the meta-clay and the ratio between the mass of the activation solution and the mass of the meta-clay is greater than 1, and in a second step the mixture using an extruder is formed into a component.

The composition according to the invention is first put together and mixed so that an essentially homogeneous mixture is created. In order to remove air bubbles from the composition, it is preferably provided that the composition is subjected to vibration and/or negative pressure after mixing. The composition is then shaped into the desired shape using an extruder (or extrusion press). For example, the extruder is used to form an endless profile of a component such as a brick, which is cut off at regular intervals to form individual bricks.

After the component has been formed, it is preferably provided that the component is hardened in a third step following the second step. Hardening is preferably carried out in the ambient air, i.e. without the addition of heat or pressure. This makes it particularly easy to produce a component such as a brick that also has high compressive strength. It is preferably provided that the curing takes place at an air temperature of at least 20° C. and at least 50% humidity (rH; relative humidity).

Curing is particularly preferably carried out at an air temperature of 20° C.-30° C. and a relative humidity of the air of 50% to 90%, preferably 50% to 80%. Under these conditions, hardening is quick, cost-efficient and avoids cracks in the components.

It is preferably provided that the mixing in the first step of the process is carried out as follows. First, the alkali silicate is mixed with water. A hydroxide is then dissolved in the alkali silicate-water mixture to obtain the activation solution.

Furthermore, the solid components, namely a base material, in particular clay and sand, are mixed with the meta-clay until a substantially homogeneous mass of the solid components is created. This step can occur simultaneously, after or before preparing the activation solution.

After the activation solution and the solid components have been provided, the activation solution is added to the solid component and mixed until an essentially homogeneous and kneadable mass is created. This mass can then be used to produce a component.

Alternatively, the individual components of the composition can also be mixed together in a different order in order to obtain a substantially homogeneous mass.

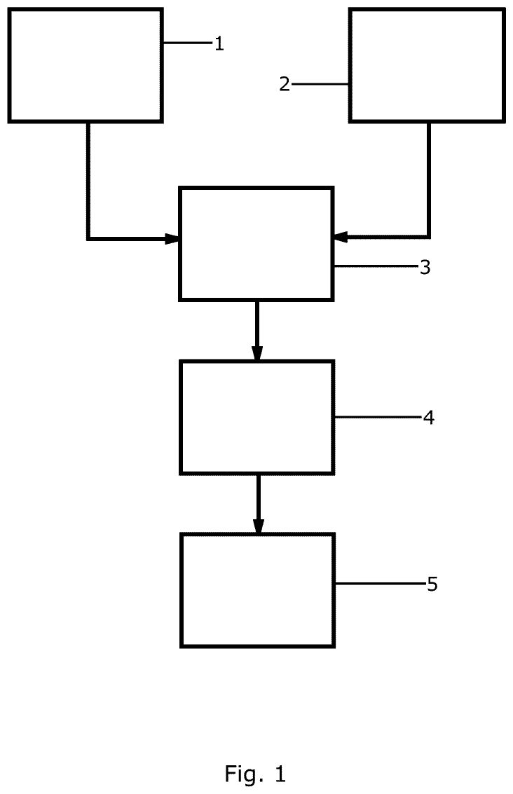

In FIG. 1 the sequence of a method according to the invention for producing a composition according to the invention is shown schematically. In section 1, an activation solution is prepared. In section 2, solid components are prepared. The mixing of the activation solution (section 1) and the mixing of the solid components (section 2) can take place simultaneously or at different times, for example one after the other. The activation solution from section 1 and the solid components from section 2 are then put together in section 3. In section 4, a mold is formed from the composition formed in section 3, for example using a mold or an extruder. The mold is then hardened in section 5.

Three examples of this process are described below.

### Example 1

In the first section 1, 1.535 kg of potassium silicate is mixed with 0.768 kg of water. 1.075 kg of potassium hydroxide is then dissolved in the potassium silicate-water mixture to obtain an activation solution.

This activation solution has approximately 45% by mass of alkali silicates in the form of potassium silicate.

Furthermore, the solid components, namely 2.205 kg of meta-kaolin, 5.066 kg of clay and 5.066 kg of quartz sand, are mixed together, for example, in a compulsory mixer in the second section 2 until an essentially homogeneous mass is created. The mass of clay and sand (quartz sand) is approx. 460% of the mass of the meta-clay in the form of meta-kaolin.

The activation solution is then added to the solid components in the third section 3 and mixed until an essentially homogeneous and kneadable mass is created (first process step). The ratio between the mass of the activation solution (3.378 kg) and the mass of the meta-clay in the form of meta-kaolin (2.205 kg) is approximately 1.53. The ratio between the mass of the activation solution (3.378 kg) and the mass of the solid components (12.337 kg) is approximately 0.27.

This kneadable mass can now be used to produce a component. In this example, the mass is fed to the feeder of an extruder in the fourth section 4 (second process step). In the vacuum chamber of the extruder, the mass is vented and a strand is extruded through the mouthpiece of the extruder, which is cut into smaller components, such as bricks, after exiting the extruder.

The resulting components are finally hardened in the fifth section 5 (third process step) at at least 20° C. and at least 50% rH (relative humidity). After 28 days, the compressive strength is determined, which is approx. 60 MPa.

### Example 2

In the first section 1, 1.520 kg of sodium silicate is mixed with 0.520 kg of water. Then 0.200 kg of sodium hydroxide is dissolved in the sodium silicate-water mixture to obtain an activation solution. This activation solution has approximately 68% by mass of alkali silicates in the form of sodium silicate.

Furthermore, the solid components, namely 1,800 kg of meta-kaolin, 3,600 kg of clay and 0.900 kg of quartz sand (with a grain size of 0.1 to 0.2 mm) are mixed together, for example, in a compulsory mixer in the second section 2 until a substantially homogeneous mass is created. The mass of clay and sand (quartz sand) is approx. 270% of the mass of meta-clay in the form of meta-kaolin.

The activation solution is then added to the solid components in the third section 3 and mixed until an essentially homogeneous and kneadable mass is created (first process step). The ratio between the mass of the activation solution (2.240 kg) and the mass of the meta-clay in the form of meta-kaolin (1.800 kg) is approximately 1.24. The ratio between the mass of the activation solution (2.240 kg) and the mass of the solid components (6.300 kg) is approximately 0.36.

This kneadable mass can now be used to produce a component. In this example, the mass is fed to the feeder of an extruder in the fourth section 4 (second process step). In the vacuum chamber of the extruder, the mass is vented and a strand is extruded through the mouthpiece of the extruder, which is cut into smaller components, such as bricks.

The resulting components are finally hardened in the fifth section 5 (third process step) at at least 20° C. and at least 50% rH (relative humidity). After 28 days, the compressive strength is determined, which is approx. 55 MPa.

### Example 3

In the first section 1, 3.700 kg of potassium silicate is mixed with 0.700 kg of water. 0.500 kg of potassium hydroxide is then dissolved in the potassium silicate-water mixture to obtain an activation solution.

This activation solution has approximately 76% by mass of alkali silicates in the form of potassium silicate.

Furthermore, the solid portions, namely 4,500 kg of meta-kaolin and 13,500 kg of quartz sand (with a grain size of 0.1 to 0.2 mm), are mixed together, for example, in a compulsory mixer in the second section 2 until a substantially homogeneous mass is created. The mass of the quartz sand is approx. 300% of the mass of the meta-clay in the form of meta-kaolin.

The activation solution is then added to the solid portion in the third section 3 and mixed until an essentially homogeneous and kneadable mass is created (first process step). The ratio between the mass of the activation solution (4,900 kg) and the mass of the meta-clay in the form of meta-kaolin (4,500 kg) is approximately 1.09. The ratio between the mass of the activation solution (4,900 kg) and the mass of the solid components (18,000 kg) is approximately 0.27.

This kneadable mass can now be used to produce a component. In this example, in the fourth section 4 (second process step), the mass is dosed into a mold, for example for a brick, and compacted and vented on a vibrating table.

The resulting components are finally hardened in the fifth section 5 (third process step) at at least 20° C. and at least 50% rH (relative humidity). After 28 days, the compressive strength is determined, which is approx. 65 MPa.

1. A Ccomposition for the production of components, comprising solid components which have at least one base material and meta-clay, as well as an activation solution, characterized in that the activation solution has more than 5% by mass of alkali silicates, the mass of the base material is 200% to 500% of the mass of the meta-clay and the ratio between the mass of the activation solution and the mass of the meta-clay is greater than 1 and between 1 and 1.6.

2. The Ccomposition according to claim 1, wherein the base material comprises sand.

3-9. (canceled)

10. The composition according to claim 2, wherein the mass of the sand is 10% to 500% of the mass of the meta-clay.

11. The composition according to claim 1, wherein the alkali silicates are sodium silicates and/or potassium silicates.

12. The composition according to claim 1, wherein the activation solution has between 20% and 90% by mass of alkali silicates.

13. The composition according to claim 1, wherein the activation solution has between 30% and 50% by mass of alkali silicates.

14. The composition according to claim 1, wherein the base material comprises clay.

15. The composition according to claim 14, wherein the mass fraction of the clay being 200% to 400% of the mass fraction of the meta-clay.

16. The composition according to claim 1, wherein the ratio between the mass of the activation solution and the mass of the meta-clay is between 1.1 and 1.6.

17. The composition according to claim 1, wherein the ratio between the mass of the activation solution and the mass of the meta-clay is between 1.25 and 1.35.

18. The composition according to claim 1, wherein the meta-clay comprises meta-kaolin.

19. A method for producing a component, in which, in a first step, a mixture of a composition comprising solid components which have at least one base material and meta-clay, as well as an activation solution, is produced, characterized in that the activation solution has more than 5 % by mass of alkali silicates, the mass of the base material is 200% to 500% of the mass of the meta-clay and the ratio between the mass of the activation solution and the mass of the meta-clay is greater than 1 and between 1 and 1.6, and in a second step the mixture using an extruder is formed into a component.

20. The method according to claim 19, wherein the component is cured in a third step following the second step.
